(19) United States
(12) Patent Application Publication
(10) Pub. No.: US 2010/0042350 A1
(43) Pub. Date: Feb. 18, 2010

(54) DOPPLER RADAR GUN CERTIFICATION SYSTEM

(75) Inventors: Robert de Wild, Nixa, MO (US); Robert Badgett, Nixa, MO (US)

Correspondence Address: LATHROP & GAGE LLP, 1845 S. NATIONAL, P.O. BOX 4288, SPRINGFIELD, MO, 65808-4288, US

(73) Assignee: CERTRITE LLC, Nixa, MO (US)

(21) Appl. No.: 12/540,191

(22) Filed: Aug. 12, 2009

Related U.S. Application Data
(60) Provisional application No. 61/088,218, filed on Aug. 12, 2008.

(51) Int. Cl. G01P 21/00; G10K 15/00; G06F 19/00

(52) U.S. Cl. 702/96; 702/103

(57) ABSTRACT

A radar gun certification system providing for the certification of doppler radar guns and associated tuning forks is described. The certification system incorporates a handheld testing device for use with a mobile computer to certify the devices. The mobile computer interfaces with a server computer which performs the test and stores the test result data. The certification system provides for the certification of radar gun devices in the patrol car by law enforcement agency personnel.

### CROSS REFERENCE TO RELATED APPLICATIONS

This non-provisional application claims priority of U.S. Provisional Patent Application No. 61/088,218 filed on Aug. 12, 2008, which application is incorporated herein by reference.

### BACKGROUND OF THE INVENTION

A Doppler radar gun certification system is described which provides for the testing and certification of radar guns and the associated tuning forks. The radar guns and tuning forks used by law enforcement agencies to enforce traffic laws must be periodically tested to certify that they detect speeds and generate frequencies within a tolerance defined by the National Institute of Standards and Technology. Existing technologies for certifying radar guns require highly trained personnel to perform the test, and may require that the radar gun be removed from the patrol car and shipped to a testing facility.

The improved system may be used by law enforcement personnel with a minimum of training, and provides for testing and certification of the radar gun without removing it from the patrol car. The improved system for certifying such radar guns and tuning forks described herein includes a handheld testing device that interfaces with a mobile computer and a server computer via a network to perform the radar gun and tuning fork certification functions, and to store certification and testing data on the server computer. The handheld testing device and mobile computer may be used to test the radar gun in a vehicle or other location without removing the radar gun from service or sending it to a testing facility.

### SUMMARY OF THE INVENTION

The radar gun certification system provides a portable handheld testing device that interfaces with software executing on a mobile computer and a server computer via a network to perform radar gun testing and certification. The handheld testing device includes a speaker for stimulating the radar gun, and a microphone for recording the audio frequency generated by the tuning fork. The handheld testing device is connected to a mobile computer which in turn is connected to a server computer over a network such as the internet. The system may be used to certify a radar gun and also to certify tuning forks used in some radar gun tests.

When certifying a radar gun, a user of the system interacts with the server computer via software on the mobile computer, triggering the server computer to send a list of appropriate frequencies to the mobile computer which generates and plays the audio signals for those frequencies through a speaker in the handheld testing device, thus testing the radar gun response to specific frequencies. The responses registered by the radar gun are input by the user through the mobile computer, and stored on the server computer. At the completion of testing, the server computer determines if the radar gun has passed the test and if a certification is appropriate.

When the system is used to certify a tuning fork a user of the system uses the microphone in the handheld testing device to record the sound produced by the tuning fork to an audio file on the mobile computer. The mobile computer then transmits the audio file to the server computer for analysis. The server computer determines the frequencies of the sound in the audio file and compares those frequencies to those appropriate to the specific tuning fork. The results of the test are stored on the server computer and transmitted to the mobile computer.

### BRIEF DESCRIPTION OF THE DRAWINGS

FIG. 1 is a schematic view of the radar gun certification system.

FIG. 2 is a diagram of a method of using the radar gun certification system.

FIG. 3 is a front view of an embodiment of the handheld testing device.

FIG. 4 is a rear view of an embodiment of the handheld testing device with the rear cover removed.

### DETAILED DESCRIPTION

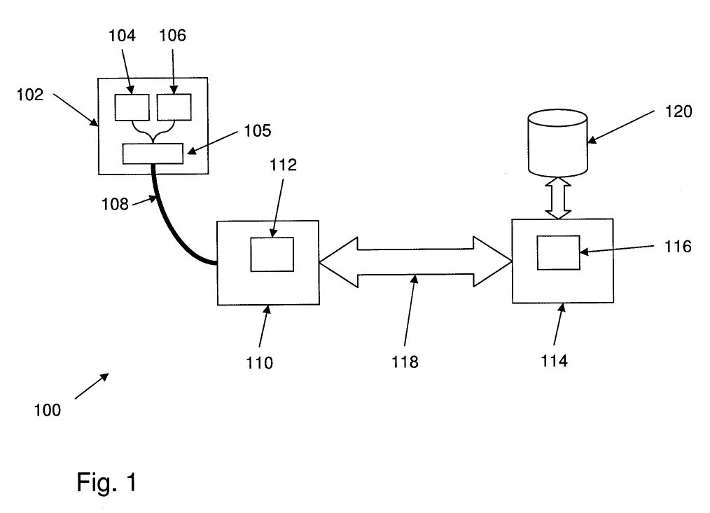

Referring to FIG. 1, the certification system 100 is shown in a schematic view. The certification system 100 includes a testing device 102 for stimulating the radar gun using sound waves and for certifying tuning forks by recording the sound waves of the tuning fork. The methods of using the testing device 102 as part of the certification system 100 are described in detail in reference to a later figure. The testing device 102 includes a microphone 104, a USB sound adapter 105, a speaker 106, and a data connector 108. Although in a preferred embodiment the microphone 104, the USB sound adapter 105, and the speaker 106 are contained in a single physical housing, in other embodiments of the certification system 100, they may be complete separate or attached only via data connector 108.

Data connector 108 contains at least one electrical conductor, and in a preferred embodiment of the certification system 100 the data connector 108 is a standard USB cable. The data connector 108, in a preferred embodiment is of sufficient length to allow the mobile computer to be located in the front of a patrol car while the handheld testing device is used to test a radar gun antenna located in the back of the patrol car. The microphone 104 and the speaker 106 are each connected to the USB sound adapter 105, which is then connected to the data connector 108. The data connector 108 connects the testing device 102 to a computer 110 using standard connectors and protocols. In a preferred embodiment of the system 100, the data connector 108 connects to a USB port on the computer 110. The data connector 108 may also connect to other types of input/output ports such as wireless data connections including Bluetooth or other wireless technologies.

The mobile computer 110 may be a general or special purpose computer, but in a preferred embodiment the computer 110 is a general purpose computer running a general purpose operating system, including, but not limited to, Macintosh, Linux, and Windows operating systems, and may be a portable handheld device, a mobile or laptop computer, or a typical desktop computer. In the preferred embodiment of the invention the general purpose operating system is Windows XP/Vista. The computer 110 may also be a cellphone, personal digital assistant or other handheld electronic device. Computer software 112 executes on computer 110, and may include, but is not limited to, a web browser. In a preferred embodiment of the system 100, the software 112 is provided by a download via a web browser. Software 112 is installed on computer 110 prior to use for testing a radar gun or tuning fork.

The computer 110 and software 112 communicate with a server computer 114. The server computer 114 may be a general or specific purpose computer, and in a preferred embodiment of the system 100 the server computer 114 is a general purpose computer running a general purpose operating system such as Linux, Macintosh or Windows. The server computer 114 may be located remotely from the computer 110. Server software 116 executes on the server computer 114, and includes web server software and file transfer protocol (ftp) server software, among others. The web server and ftp server software may be replaced with other technologies that provide similar functionality for remote procedure calls and file transfer. Server software 116 also includes software to analyze sound files received from the mobile computer 110 using the Fourier Transform algorithm.

The server computer 114 may also transmit executable code or scripts to computer 110, which, in a preferred embodiment, are executed locally on the computer 110 by the web browser or a plug-in or extension thereof. Such downloaded componets are included as part of software 112.

Communication between the computer 110 and the server computer 114 occurs over a computer network 118. The network 118 may be any data communications network for interconnecting computer systems. In a preferred embodiment of the system 100, the network 118 is a wide area network such as the internet.

The server software 116 sends and receives data to and from computer 110, and also retrieves and stores data in database 120. The types of data collected are discussed in more detail during the detailed descriptions of the methods of use of the system 100. Certain portions of the data sent by server computer 116 to computer 110 are in the form of HTML documents, and may include images, text, scripts, and other embedded documents and executable programs of various kinds used and known in the software industry. The server software 116 also sends data that contains information about frequencies and miles per hour (MPH) for specific radar gunds and band to the mobile computer 110. The audio signals are then generated on the mobile computer 110, as described below, to stimulate the radar device for purposes of testing it, and received for processing to certify a tuning fork for use.

The database 120 also stores a mapping of known frequencies to values of miles per hour. The frequency mappings indicate the correct reading of miles per hour that should be registered by a radar gun system when a certain frequency is received by the gun. For example, a radar gun operating on the Ka band should register a reading of 25 miles per hour when it detects a nominal frequency of 2,587.17 Hertz. The mapping data stored in the database 120 is available from the National Institute of Standards and Technology.

The computer 110 accepts data from a user of the system 100 by means of a user interface. In a preferred embodiment the user interface is a web page displayed in a web browser on computer 110. The user interface may also be a computer program coded specifically for the purpose of interfacing with the user for purposes of the system 100. The computer 110 also accepts data from the testing device 102. The various types of data accepted from the user and the testing device are sent by the software 112 to the server computer 114 for processing by the server software 116. The server software 116 accepts the data from software 112 and may store it in the database 120, retrieve other related data from database 120 to return to computer 110, and compare the received data to previously stored data to determine security authorization and to perform certification testing of radar guns and tuning forks.

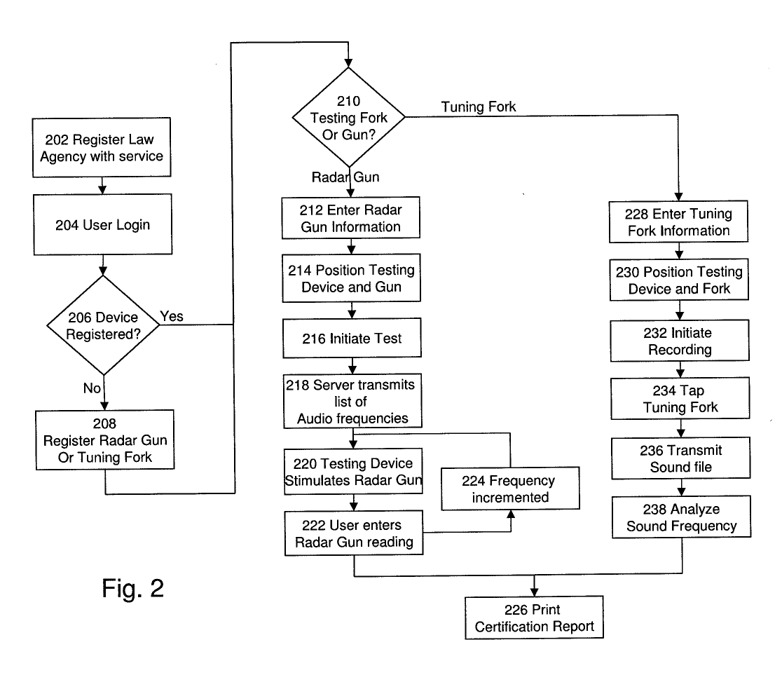

Referring now to FIG. 2, a method of using the system 100 to test and certify radar gun systems and tuning forks is described. A law enforcement agency that wishes to use the certification system 100 accesses it through a wide area network, such as the internet, from computer 110 or some other similar computer. In registration 202, the agency accesses the server computer 114 and portions of server software 116 to register its information in the system 100. The information provided as part of registration 202 includes, but is not limited to, the name of the agency, contact and billing information for the agency, and the names and security credentials for users authorized to access the system on behalf of the agency. During registration 202, the agency may proceed to register all radar guns and tuning forks as described below in device registration 208. The information provided by the agency during the registration process is stored in database 120.

After an agency is registered with the system 100 in registration 202, users authorized by the agency may log into the system 100 via login 204. Login 204 provides both authorization to a user and also verifies the identity of the user. The login 204 verifies the identity of the user by means of a password, but may also use biometric or other identification means known to the industry to verify the users identity. The user may also provide or update profile information about herself, such as name and preference information.

Once a user is logged into the system 100, a radar gun or tuning fork may be selected for testing, or a new device registered with the system to be tested. Device registration 208 allows the user to input data regarding the device. In a preferred embodiment of the system 100, the device data is input into a web browser form provided by server software 116 to a web browser running on computer 110. The data input by the user for a radar gun device includes, but is not limited to, the serial number of the radar gun and the frequency band to be tested. The data input for a tuning fork includes, but is not limited to, the serial number of the tuning fork and the frequency identifier information engraved on the tuning fork.

The data input by the user as part of device registration 208 is transmitted by software 112 to server software 116. This may be by means of an HTML POST or GET transaction, invocation by the software 112 of a web service on the server computer 114 or by other methods of interprocess communication known in the field of computer science.

After the device to be tested has been registered with the system 100, it may be tested according to the appropriate method depending on the type of device, radar gun or tuning fork. The user indicates through selection 210 to the system which type of device will be tested, and based on that selection the software 116 provides the appropriate inputs and functions to the user.

### Radar Gun Certification

Referring still to FIG. 2, when the user selects the radar gun test in step 210 the software 112 prompts for and accepts the radar gun serial number and the frequency band of the gun from the user in step 212. In a preferred embodiment of the system 100, the serial number and other radar gun information is manually entered into the software 112. In other embodiments it is possible to use radio frequency id tags or similar technology to automatically transfer the radar gun information from the gun to the software 112.

The server software stores in database 120 all test results for each radar gun along with additional information such as the user performing the test, the date of the test, and result of each frequency test. In step 214, the user then positions testing device 102 in relation to the radar gun so that the speaker 106 will cause the gun to register a reading in miles per hour, and then initiates the test through the user interface on computer 110.

Once the test is initiated by the user, the server software 116, in step 218, generates a list of audio frequencies based on the frequency band of the radar gun and transmits them via the network 118 to computer 110. In step 220, computer 110 then generates audio signals at the indicated frequencies and transmits them to the handheld testing device 102 which then plays the audio frequency signals through the speaker 106. The resulting sound stimulates the radar gun to register a reading in miles per hour, which, in step 222, is read by the user and input through software 112 and communicated to server software 116, by similar means to that described above. Server software 116 then stores the radar gun reading in database 120 and computer 110 repeats the process for an incremented audio frequency 224 until readings have been received for all audio frequency signals for the frequency band of the radar gun listed by server software 116 in step 218.

After the radar gun readings have been recorded for each desired audio frequency signal, the results input by the user are compared to the correct readings that the radar gun should have registered. If the radar gun readings are within an acceptable margin of error then the radar gun has passed the test and is certified for continued use. The success or failure of the test is presented to the user via data sent from server software 116 to computer 110 in step 226.

The system stores the data in database 120, and the user may access the data later from computer 110 or another similar computer and print a certification report 226 setting forth the results of the test. A user of the system may also access historical test results from database 120 through server software 116 for a specific radar gun, and may compare the test results for a given radar gun over time.

### Tuning Fork Certification

If the user selects the tuning fork certification in selection 210, the computer software 112 prompts the user for the serial number and engraved frequency of the tuning fork through the user interface in step 228. The user then positions in step 230 the testing device 102 in relation to the tuning fork so that the sound generated by the tuning fork will be recorded by the microphone 104 in the testing device 102. The user then initiates the recording process 232 through the user interface on computer 110 and taps the tuning fork 234. In a preferred embodiment, the microphone 104 provides an analog electrical audio signal to the USB sound adapter 105 which then converts it to a digital signal and transmits it to computer 110, which is then transmitted in step 236 to the server computer 114 through the ftp software included in server software 116, or some similarly functioning file transmission technology. Alternatively, the testing device 102 may produce a digital representation of the audio signal and provide the digital representation to the server computer 114.

In step 238, server computer 114 receives the digital representation of the audio signal generated from the tuning fork. Server software 116 includes components that are capable of analyzing the digital representation of the audio signal to determine the frequency of the signal contained therein. In a preferred embodiment of the system the frequency analysis component is implements a Fourier Transform algorithm to analyze the frequence of a the digital representation of the audio signal.

The frequency analysis component of the server software determines the recorded frequency of the tuning fork signal and stores it in database 120. The server software 116 also compares the recorded frequency of the tuning fork to the nominal frequency of the tuning fork as engraved on it. If the recorded frequency is within allowed tolerances of the nominal frequency the tuning fork is certified for use, and in either case, the result is returned by the server computer 114 to the software 112 in step 226.

After completing either type of test, a user may print a report listing the results of the test in step 226 through the software 112 provided on computer 110.

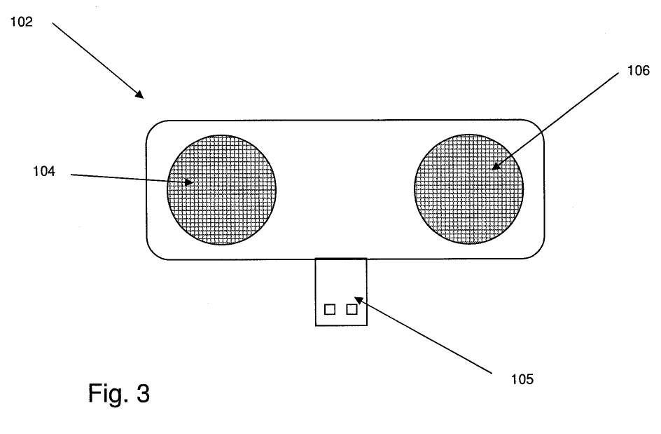

Referring now to FIG. 3, a front view of an embodiment of the handheld testing device 102 is shown. The device 102 case encloses microphone 104, speaker 106 and USB sound adapter 105.

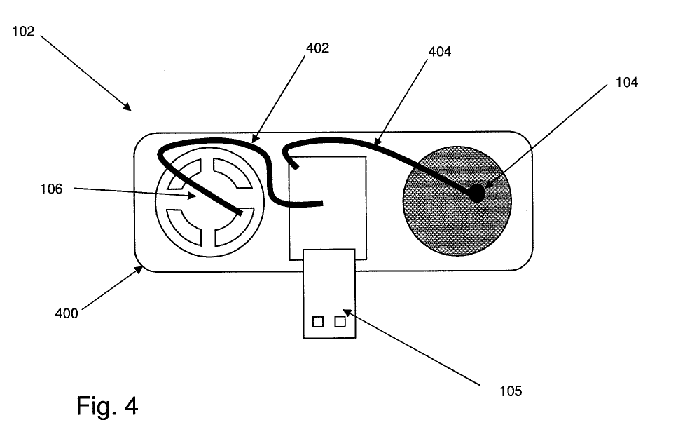

Referring now to FIG. 4, a back view of an embodiment of the handheld testing device 102 is shown with the back cover removed. Microphone 104 and speaker 106 are attached to USB sound adapter 105 via electrical conductors 402 and 404. The USB connector portion of adapter 105 extends through the case 400 of device 102 for connection to data connector 108.

What is claimed is:

1. A radar gun certification system comprising:
a testing device;
a mobile computer;
a server computer;
wherein the server computer sends and receives data to and from the mobile computer; and
wherein the testing device is electrically or wirelessly connected to the mobile computer for receiving or transmitting audio signals.

2. The radar gun certification system of claim 1 wherein the testing device is comprised of a speaker and a microphone.

3. The radar gun certification system of claim 1 wherein the server computer stores the data received from the mobile computer in a database.

4. The radar gun certification system of claim 1 wherein the mobile computer is connected to the server computer by means of a wireless data network.

5. The radar gun certification system of claim 1 wherein the mobile computer is a laptop computer, a handheld computer, a personal digital assistant, an electronic organizer, or a mobile telephone handset.

6. The radar gun certification system of claim 1 wherein the testing device is incorporated into the mobile computer.

7. The radar gun certification system of claim 1 wherein the mobile computer is connected to the server computer over a global data communications network.

8. A method for certifying a radar gun system, comprising the steps of:
providing a radar gun system to be certified;
providing a testing device containing a speaker;
providing a mobile computer connected to the testing device;
providing a server computer connected to the mobile computer via a data network;
transmitting a list of audio frequencies from the server computer to the mobile computer;
generating an audio signal on the mobile computer;
transmitting the audio signal to the testing device;
playing the audio signal through the testing device to stimulate the radar gun system;
entering a speed value registered by the radar gun into computer 110; and
transmitting the speed value registered by the radar gun system from the mobile computer to the server computer.

9. The method of claim 8 further comprising the step of:
storing the speed value and the nominal frequency in a database connected to the server computer.

10. A method for certifying a tuning fork, comprising the steps of:
providing a tuning fork to be certified with a nominal frequency value;
providing a testing device containing a microphone;
providing a mobile computer connected to the testing device;
providing a server computer connected to the mobile computer via a data network;
transmitting an audio signal from the testing device to the mobile computer;
converting the audio signal to a digital representation;
transmitting the digital representation of the audio signal to the server computer;
analyzing the digital representation of the audio signal on the server computer to assign a recorded frequency value to the audio signal; and
comparing the recorded frequency to the nominal frequency.

11. The method of claim 10 further comprising the step of:
storing the recorded frequency and the nominal frequency in a database connected to the server computer.
